(19) United States
(12) Patent Application Publication
(10) Pub. No.: US 2013/0286829 A1
(43) Pub. Date: Oct. 31, 2013

(54) BASE STATION AND COMMUNICATION CONTROL METHOD

(71) Applicants: Minami Ishii, Chiyoda-ku (JP); Tadashi Uchiyama, Chiyoda-ku (JP); Toshihisa Sekikawa, Chiyoda-ku (JP)

(72) Inventors: Minami Ishii, Chiyoda-ku (JP); Tadashi Uchiyama, Chiyoda-ku (JP); Toshihisa Sekikawa, Chiyoda-ku (JP)

(73) Assignee: NTT DOCOMO, INC., Tokyo (JP)

(21) Appl. No.: 13/980,066

(22) PCT Filed: Mar. 27, 2012
(86) PCT No.: PCT/JP2012/058019

§ 371 Date: Jul. 17, 2013

(51) Int. Cl. H04W 48/06

(52) U.S. Cl. CPC H04W 48/06
USPC 370/230

(57) ABSTRACT

A base station includes a congestion state determination unit that determines whether the base station is in a congestion state; a barring target setting unit that sequentially sets targets of barring among a plurality of the targets of the barring when a determination is made that it is the congestion state; a barring time interval setting unit that sets a time interval of the barring based on the congestion state when the determination is made that it is the congestion state; and a transmitter that transmits information representing the targets of the barring and information representing the time interval of the barring to the user equipment.

### TECHNICAL FIELD

The present invention relates to a radio communication system.

### BACKGROUND ART

The specifications of Long Term Evolution (LTE) have been developed by a standardization organization of mobile communication systems, which is 3rd Generation Partnership Project (3GPP). LTE achieves high-speed communication, where 100 Mbps or more is achieved for a downlink and 50 Mbps or more is achieved for an uplink. For LTE, attempts are made to improve the latency and frequency utilization efficiency.

### RELATED ART DOCUMENT

### Non-Patent Document

3GPP TS 36.331 V10.0.0 (5.2 System information 5.2.1 Introduction) 2010-12

### SUMMARY OF THE INVENTION

### Problem to be Solved by the Invention

Due to concentration of access from user terminals (user equipment), it is possible that load is increased and congestion occurs in a base station (eNodeB). Specifically, congestion in a device is assumed for a case where access is concentrated due to an event such as a new year event; a case where access is concentrated due to occurrence of a disaster; a case where access is concentrated due to occurrence of an accident; and a case where access is concentrated during activation of a base station. Depending on an extent of the congestion, the base station may not operate normally. In the worst case, it is possible that a packet is lost in the base station or state of the base station becomes an operation shutdown mode.

An object of the disclosed base station is to reduce the load.

### Means for Solving the Problem

The disclosed base station according to one embodiment is a base station that performs radio communication with user equipment. The base station includes a congestion state determination unit that determines whether the base station is in a congestion state; a barring target setting unit that sequentially sets targets to be barred among a plurality of the targets to be barred when the congestion state determination unit determines that the base station is in the congestion state; a barring time interval setting unit that sets a time interval during which the barring is to be performed based on the congestion state, when the congestion state determination unit determines that the base station is in the congestion state; a notification information generating unit that generates information representing the targets to be barred and information representing the time interval of the barring, wherein the targets to be barred are to be set by the barring target setting unit and the time interval of the barring is to be set by the barring time interval setting unit; and a transmitter that transmits the information which is generated by the notification information generating unit to the user equipment.

The disclosed communication control method according to one embodiment is a communication control method of a base station that performs radio communication with user equipment. The communication control method includes a congestion state determination step of determining whether the base station is in a congestion state; a barring target setting step of sequentially setting targets to be barred among a plurality of the targets to be barred when the congestion state determination step determines that the base station is in the congestion state; a barring time interval setting step of setting a time interval during which barring is to be performed based on the congestion state when the congestion state determination step determines that the base station is in the congestion state; a notification information generating step of generating information representing the targets to be barred and information representing the time interval of the barring, wherein the targets to be barred are to be set by the barring target setting step and the time interval of the barring is to be set by the barring time interval setting step; and a transmitting step of transmitting the information which is generated by the notification information generating step to the user equipment.

### Effect of the Present Invention

According to the disclosed embodiment, the load on the base station can be reduced.

### BRIEF DESCRIPTION OF THE DRAWINGS

FIG. 1 is a diagram showing one example of a radio communication system;

FIG. 2 is a functional block diagram showing one example of an eNodeB;

FIG. 3 is a diagram showing one example of transmission of system information;

FIG. 4 is a flowchart showing one example of operations of the eNodeB; and

FIG. 5 is a diagram showing the example of the operations of the eNodeB.

### EMBODIMENTS FOR CARRYING OUT THE INVENTION

Next, a configuration for implementing the present invention is explained based on the following embodiment, while referring to the drawings. Here, in all the drawings for explaining the embodiment, the same reference numerals are used for entities having the same functions, thereby omitting repeated explanations.

### Embodiment

<Radio Communication System>

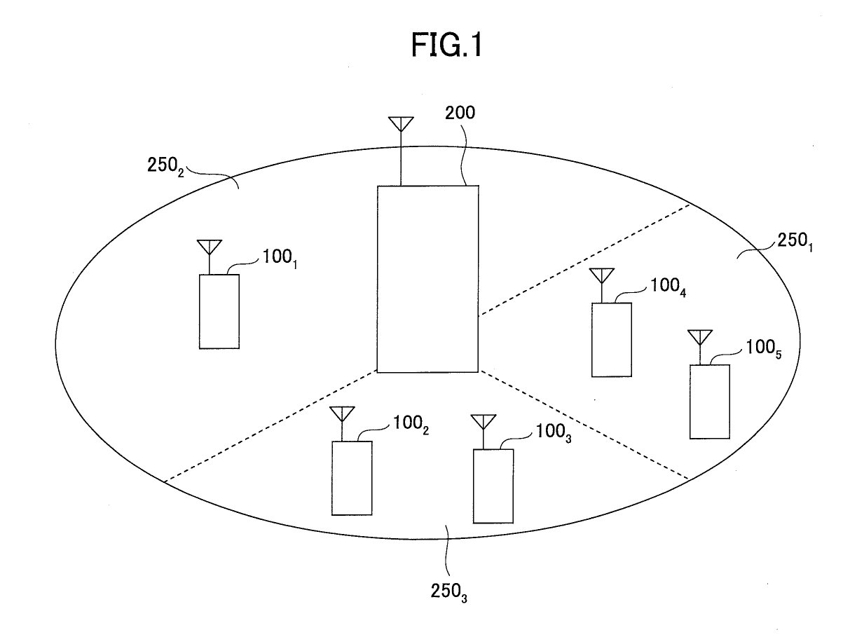

FIG. 1 is one example of a radio communication system.

The radio communication system includes a base station (eNB: eNodeB) 200 and a user terminal (UE: User Equipment) 100ₙ (n is an integer such that n>0). FIG. 1 shows the example where n=5.

A Mobility Management Entity (MME)/Serving-Gateway (S-GW) (not shown) is installed at an upper level of the eNodeB 200. The MME/S-GW is included in a core network, and the MME/S-GW terminates a non-access stratum (NAS). The MME/S-GW manages user equipment in an idle state, and the MME/S-GW manages System Architecture Evolution (SAE) bearer resources. The MME/S-GW may be referred to as a “core node.”

The eNodeB 200 causes an uplink signal to the eNodeB 200 to be barred for a predetermined case. Further, the eNodeB 200 may cause uplink signals to the eNodeB 200 to be decreased for the predetermined case. The predetermined case includes a case where the eNodeB 200 is congested.

When the eNodeB 200 bars the uplink signal to the eNodeB 200, the eNodeB 200 performs the following processing.

The eNodeB 200 bars the uplink signal to the eNodeB 200 by switching a target of barring. By switching the target of the barring, the user equipment which corresponds to the target of the barring is switched. Thus, an uplink signal from each of the user terminals can be evenly barred.

<Example of Target of Barring>

<Cell>

The target of the barring includes a cell.

An area which is covered by the eNodeB 200 includes one or more cells 250ₘ (m is an integer such that m>0). In the example shown in FIG. 1, the area covered by the eNodeB 200 includes a cell 250₁, a cell 250₂, and a cell 250₃. The area which is covered by the eNodeB 200 may be one or two cells, or the area covered by the eNodeB 200 may be four or more cells. The cells 250₁, 250₂, and 250₃ may be referred to as “sectors.” The cells include cells where radio communications are possible on the same frequency bands, and cells where radio communications are possible on different frequency bands. Specifically, a plurality of the cells that is covered by the eNodeB 200 is set to, be the targets of the barring. Namely, among the cells, the cell which is the target of the barring is sequentially switched. When the cell which is the target of the barring is sequentially switched, the cell which is to be barred may be specified by a frequency band. Alternatively, a sector which is to be the target of the barring may be specified.

Further, the cell which is covered by the eNodeB 200 may be switched in an eNodeB 200 by eNodeB 200 basis. Specifically, a cell which is covered by a plurality of the eNodeBs may be switched. The switching of the cell, which is on the eNodeB by eNodeB basis, may be performed by an apparatus having an operation, administration, and maintenance (OAM) function on a network.

<Type of Call>

The target of the barring includes a type of a call.

Specifically, the types of calls include mobile originated (MO) signaling from the user equipment 100ₙ, a mobile originated call (MO data) from the user equipment 100ₙ, and a circuit switch (CS) service.

The mobile originated signaling from the user equipment 100ₙ includes location registration and “Attach.”

The eNodeB 200 switches the type of the call as the target of the barring. For switching the type of the call, the subject of the barring may be switched in a predetermined order among the mobile originated signaling from the user equipment 100ₙ; the mobile originated call from the user equipment 100ₙ, and the circuit switch service. The subject of the barring may be randomly switched.

The mobile originated signaling from the user equipment 100ₙ is barred by switching the target of the barring to be the mobile originated signaling from the user equipment 100ₙ. Namely, an attach request signal is not transmitted from the user equipment 100ₙ, even for a case where a user turns on a power supply of the user equipment 100ₙ and the attach request signal is to be transmitted under a normal circumstance. Further, a location registration signal is not transmitted from the user equipment 100ₙ, even for a case where a location registration area of the user equipment 100ₙ is changed and the location registration signal is to be transmitted under a normal circumstance. The mobile originated call from the user equipment 100ₙ is described when the target of the barring is switched to the mobile originated call from the user equipment 100ₙ. Namely, a signal which is to be transmitted during the mobile originated call from the user equipment 100ₙ is not transmitted, even if the user performs an operation for the mobile originated call. The user equipment 100ₙ may indicate that the mobile originated call is barred. Specifically, when the user performs the operation for the mobile originated call, indication may be made that the mobile originated call is barred. The eNodeB 200 may avoid performing the process which is for the signal to be transmitted during the mobile originated call, even if the user performs the operation for the mobile originated call, and the signal, which is to be transmitted during the mobile originated call, is transmitted from the user equipment 100ₙ.

Further, the target of the barring may be switched to an incoming call toward the user equipment 100ₙ. The incoming call toward the user equipment 100ₙ is barred by switching the target of the barring to the incoming call toward the user equipment 100ₙ. Namely, an incoming call toward the user equipment 100ₙ by another user is not received, even if the other user performs an operation for the incoming call toward the user equipment, which is the target of the barring. A notification may be made that the incoming call is barred. Specifically, when the operation for the incoming call is performed by the other user, a notification may be made that the destination user equipment is barred. The eNodeB 200 may avoid performing the process corresponding to a signal which is to be transmitted during the incoming call, even if the other user performs the operation for the incoming call, and the signal, which is to be transmitted during the incoming call, is transmitted from the user equipment 100ₙ of the other user.

When the target of the barring is switched to the circuit switch service, the circuit switch service of the user equipment 100ₙ is barred. For the user equipment 100ₙ, the circuit switch service is barred. However, the user equipment 100ₙ can perform communication by a packet switch service.

<Types of User Equipment>

The targets of the barring include types of the user equipment 100ₙ.

Specifically, the types of the user equipment 100ₙ may include user equipment of a general user; user equipment of a user who is preferentially connected; and user equipment of a person who performs maintenance or the like. The types of the user equipment may be specified by an access class.

By switching the target of the barring to be the user equipment of the general user, communication from the user equipment of the general user is barred. When the communication from the user equipment of the general user is barred, a signal from the user equipment of the general user is not transmitted to the eNodeB 200. Further, a signal may be prevented from being transmitted from the eNodeB 200 to the user equipment of the general user.

By switching the target of the barring to be the user equipment of the user who is preferentially connected, communication from the user equipment of the user who is preferentially connected is barred. When the communication from the user equipment of the user who is preferentially connected is barred, a signal from the user equipment of the user who is preferentially connected is not transmitted to the eNodeB 200. Further, a signal may be prevented from being transmitted from the eNodeB 200 to the user equipment of the user who is preferentially connected.

By switching the target of the barring to the user equipment of the person who performs maintenance or the like, communication from the user equipment of the person who performs maintenance or the like is barred. When the communication from the user equipment of the person who performs maintenance or the like is barred, a signal from the user equipment of the person who performs maintenance or the like is not transmitted to the eNodeB 200. Further, a signal may be prevented from being transmitted from the eNodeB 200 to the user equipment of the person who performs maintenance or the like.

It is preferable that a frequency of switching the target of the barring to be the user equipment of the user who is preferentially connected be smaller than a frequency of switching the target of the barring to be the user equipment of the general user, and a frequency of switching the target of the barring to be the user equipment of the person who performs maintenance or the like. That is because the user is to be preferentially connected compared to the general user or the person who performs maintenance or the like.

<Function of eNodeB>

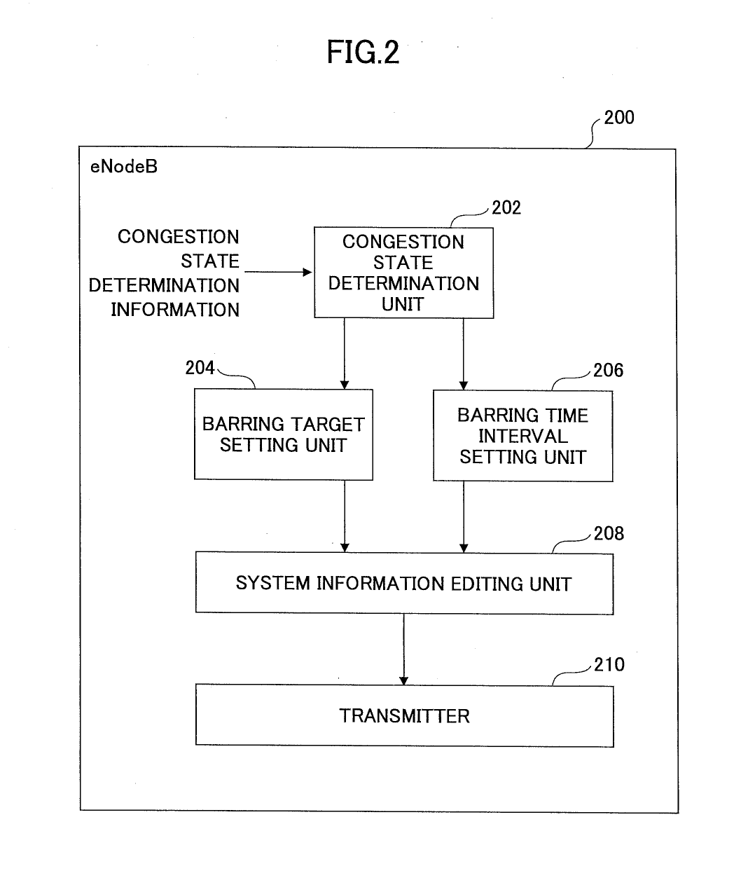

FIG. 2 shows an embodiment of the eNodeB 200.

The eNodeB 200 includes a congestion state determination unit 202. The congestion state determination unit 202 determines whether the eNodeB 200 is in a congestion state, based on information for determining the congestion state of the eNodeB 200 (which is referred to as the “congestion state determination information,” hereinafter). Specifically, information indicating a utilization rate of a CPU (which is referred to as the “CPU utilization rate,” hereinafter), which is installed in the eNodeB 200, is input to the congestion state determination unit 202 as the congestion state determination information. The congestion state determination unit 202 may determine whether the eNodeB 200 is in the congestion state, based on the CPU utilization rate. When a plurality of the CPUs is installed, an average value may be used. Alternatively, among CPU utilization rates, the maximum value or the minimum value of the CPU utilization rates may be used. Additionally, the CPU utilization rate may be calculated by performing predetermined statistical processing.

Further, a degree (level) of the congestion may be determined based on the CPU utilization rate. When the congestion state determination unit 202 determines that the eNodeB 200 is in a congestion state, the congestion state determination unit 202 reports to a barring target setting unit 204 and a barring time interval setting unit 206 that the state is the congestion state. The level of the congestion and the congestion state may be reported together. By reporting the level of the congestion, the congestion state may be reported. As the level of the congestion, the CPU utilization rate may be reported.

The eNodeB 200 includes the barring target setting unit 204. The barring target setting unit 204 is connected to the congestion state determination unit 202. When the congestion state determination unit 202 reports to the barring target setting unit 204 that the eNodeB 200 is in the congestion state, the barring target setting unit 204 sets a target to be barred. Specifically, it is selected among a cell, a type of a call, and a type of user equipment. One of the cell, the type of the call, and the type of the user equipment may be selected. Two or more of the cell, the type of the call, and the type of the user equipment may be selected. All of the cell, the type of the call, and the type of the user equipment may be selected. Among the cell, the type of the call, and the type of the user equipment, an order of selecting the target to be barred may be defined in advance. The barring target setting unit 204 selects the target to be barred in accordance with the order.

The barring target setting unit 204 defines a subject of the barring for the selected target of the barring.

Specifically, when the cell is selected as the target of the barring, a frequency of a cell to be barred and the cell to be barred may be defined as the subjects to be barred. When the cell is switched as the target of the barring on an eNodeB-by-eNodeB basis, and when the eNodeB is the target of the barring, the barring target setting unit 204 may set it to be all the cells within the eNodeB, which is the target of the barring. Namely, when a device having the operation, administration, and maintenance function on the network reports that the eNodeB is the target of the barring, the barring target setting unit 204 may set that all the cells included in the eNodeB are the target cells to be barred.

When the type of the call is selected as the target of the barring, the subject of the barring may be selected among a transmission signal from user equipment, a call originating from user equipment, and a circuit switch service. One of, two of, or all of the transmission signal from the user equipment, the call originating from the user equipment, and the circuit switch service may be selected.

When the type of the user equipment is selected as the target of the barring, the subject of the barring may be selected among the user equipment of the general user, the user equipment of the user who is preferentially connected, and the user equipment of the person who performs maintenance or the like. One of, two of, or all of the user equipment of the general user, the user equipment of the user who is preferentially connected, and the user equipment of the person who performs maintenance or the like may be selected.

The barring target setting unit 204 inputs information representing the target of the barring and information representing the subject of the barring to a system information editing unit 208.

The eNodeB 200 includes the barring time interval setting unit 206. The barring time interval setting unit 206 is connected to the congestion state determination unit 202. When the barring time interval setting unit 206 is informed by the congestion state determination unit 202 that the eNodeB 200 is in the congestion state, the barring time interval setting unit 206 sets a time interval of the barring. Specifically, the time interval of the barring may be defined in a single uniform way, and the thus defined time interval may be set. Alternatively, the time interval of the barring may be selected depending on the level of the congestion. The time interval of the barring is elongated, when the level of the congestion is large. That is because it is assumed that a longer time interval is required for resolving the congestion, when the level of the congestion is large. In other words, the time interval of the barring is elongated, when the CPU utilization rate is large. Specifically, as time intervals of the barring, selection candidates may be defined in advance. Concretely, the barring time interval setting unit 206 may select the time interval of the barring among 1, 5, 10, 20, 30, and 60 seconds. The barring time interval setting unit 206 inputs information representing the time interval of the barring to the system information editing unit 208.

The eNodeB 200 includes the system information editing unit 208. The system information editing unit 208 is connected to the barring target setting unit 204 and to the barring time interval setting unit 206. The barring target setting unit 204 inputs information representing the target of the barring and information indicating the subject of the barring to the system information editing unit 208. Further, the barring time interval setting unit 206 inputs information representing the time interval of the barring to the system information editing unit 208.

When the information representing the target of the barring, the information indicating the subject of the barring, and the information representing the time interval of the barring are input, the system information editing unit 208 includes information which indicates that broadcast information is changed in a paging message. Namely, when the information representing the target of the barring, the information indicating the subject of the barring, and the information representing the time interval of the barring are input, system information is changed. Thus, a systemInfoModification Information Element is included in the paging message.

Further, the system information editing unit 208 edits the system information which includes the information representing the target of the barring, which is input by the barring target setting unit 204; the information representing the subject of the barring, which is input by the barring target setting unit 204; and the information representing the time interval of the barring, which is input by the barring time interval setting unit 206. Namely, the system information editing unit 208 updates a systemInfoValueTag IE of a system information block 1 (SIB1).

The system information editing unit 208 inputs the paging message and the system information to a transmitter 210.

The eNodeB 200 includes the transmitter 210. The transmitter 210 is connected to the system information editing unit 208. The transmitter 210 transmits the paging message, which is input by the system information editing unit 208. The paging message includes the information indicating that the broadcast information is changed. Additionally, the transmitter 210 transmits the system information, which is input by the system information editing unit 208.

<Example of Transmission of the System Information>

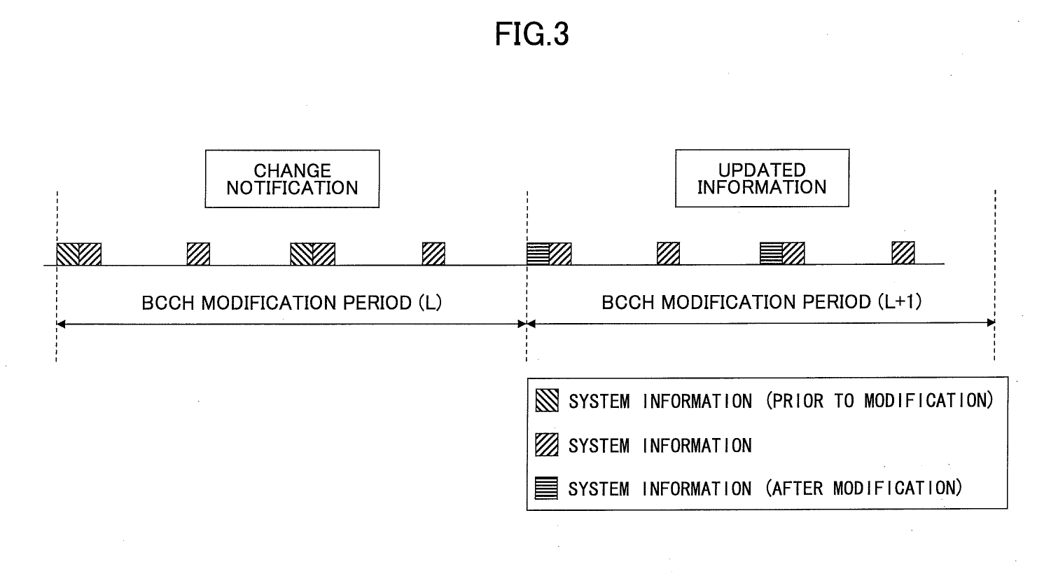

FIG. 3 shows an example of transmission of the system information. In FIG. 3, a horizontal axis represents time. The broadcast channel which is transmitted by the eNodeB 200 is changed in a unit of a broadcast control channel (BCCH) modification period. In the example shown in FIG. 3, notification is made that the information included in the system information is to be changed (Change notification) in a BCCH modification period (L). Notification of the system information including the changed information (Updated information) is made in a BCCH modification period (L+1).

The transmitter 210 transmits the paging message from the system information editing unit 208. The paging message includes the systemInforModification Information Element. The transmitter 210 may transmit the paging message which is specified so that it is received by all units of the user equipment. The transmitter 210 may transmit the paging message which specifies units of the user equipment which are to receive the paging message.

Specifically, when a cell is selected as the target of the barring, and when the cell which is to be barred is specified by a frequency band, units of the user equipment which perform radio communication in the frequency band may be specified by the paging message. When a cell is selected as the target of the barring, and when the cell which is to be barred is specified by a sector, units of the user equipment which perform radio communication in the sector may be specified by the paging message. When a cell which is covered by the eNodeB 200 is switched in a unit of the eNodeB 200, units of the user equipment which perform radio communication in the cell which is covered by the eNodeB 200 may be specified by the paging message.

When a type of a call is selected as the target of the barring, units of the user equipment which perform radio communication in a cell which is covered by the eNodeB 200 may be specified by the paging message.

When a type of user equipment is selected as the target of the barring, units of the user equipment which are to be barred may be specified by the paging message.

By transmitting the paging message, a notification can be made to the user equipment 100 that the system information is changed.

The transmitter 210 transmits the system information. The transmitter 210 transmits system information including the same information during the BCCH modification period, in units of the BCCH modification period. The system information is transmitted so that it is received by units of the user equipment, which are the targets of the barring.

Specifically, when a cell is selected as the target of the barring, and the cell which is to be barred is specified by a frequency band, the system information is transmitted in the frequency band to the cell which is the target of control. When a cell is selected as the target of the barring, and the cell which is to be barred is specified by a sector, the system information is transmitted within the sector. Further, when a cell which is covered by the eNodeB 200 is switched in a unit of the eNodeB 200, the system information is transmitted in a cell which is the target of the control among the cells which are covered by the eNodeB 200.

When a type of a call is selected as the target of the barring, the system information is transmitted in a cell which is the target of the control among the cells which are covered by the eNodeB 200.

When a type of user equipment is selected as the target of the barring, the system information is transmitted in a cell which is the target of the control among the cells which are covered by the eNodeB 200.

When there is a plurality of targets of the barring, the system information may be transmitted in an overlapped area among areas. Here, in each of the areas, the system information corresponding to the target of the barring is to be transmitted. Alternatively, when there is the plurality of the targets of the barring, the system information pieces may be transmitted in all the corresponding areas in which the system information pieces are to be transmitted.

In the example shown in FIG. 3, the transmitter 210 transmits system information including the same information four times in the BCCH modification period. The transmitter 210 continues transmitting the system information, which is transmitted when the system information is input from the system information editing unit 208, until the expiration of the BCCH modification period. After the expiration of the BCCH modification period, the transmitter 210 transmits the system information including the modified information in the next BCCH modification period.

<Operations of the eNodeB>

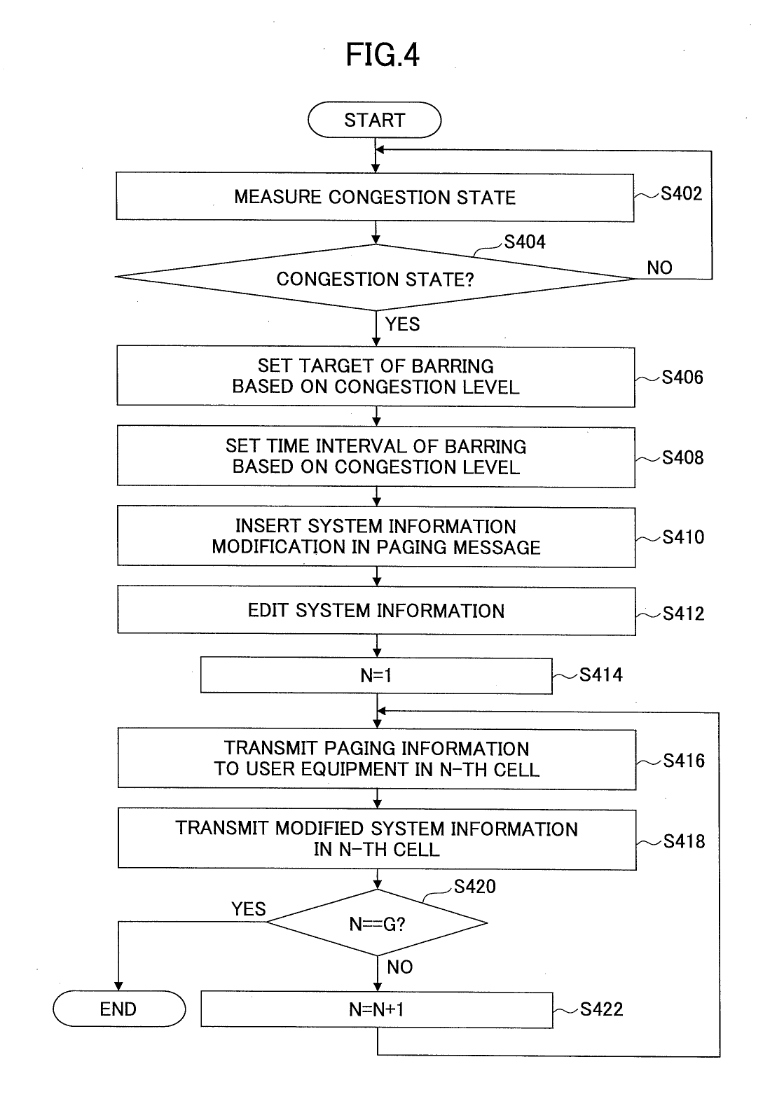

FIG. 4 shows an example of operations of the eNodeB 200. In FIG. 4, N represents an identification number of a cell, and G represents a number of the cells included in the eNodeB 200. Here, G may be a number of cells which are targets of the barring in the eNodeB 200. That is because it is possible that the cells which are to be the targets of the barring are a part of the cells which are controlled by the eNodeB.

As an example of the operations of the eNodeB 200, a case is shown in which a mobile originated call from user equipment of a general user is barred on a cell-by-cell basis.

The eNodeB 200 measures the congestion state (step S402). Namely, the eNodeB 200 requests the congestion state determination information. The process of requesting the congestion state determination information may be performed regularly, or irregularly. Specifically, the CPU utilization rate is requested.

The eNodeB 200 determines whether it is the congestion state (step S404). Namely, the congestion determination unit 202 determines whether the eNodeB 200 is in the congestion state, based on the congestion state determination information, which is requested at step S402.

When a determination is made that it is not the congestion state (step S404: NO), the process returns to step S402. Namely, the process of switching the target of the barring is not performed. Since the process of switching the target of the barring is not performed, an amount of signals which are transmitted and received between the eNodeB 200 and the user equipment 100ₙ is not barred.

When a determination is made that it is the congestion state (step S404: YES), the eNodeB 200 selects a target of the barring (step S406). The target of the barring may be selected based on a congestion level. Namely, the barring target setting unit 204 selects a target of the barring, among the cell, the type of the call, and the type of the user equipment. One of the cell, the type of the call, and the type of the user equipment may be selected, or two or more of them may be selected.

When the cell is set to be the target of the barring, a frequency band of the cell or a sector may be selected as the subject of the barring. Both the frequency band of the cell and the sector may be selected.

When the frequency band of the cell is selected as the subject of the barring, the frequency band of the cell, which is to be barred, is sequentially switched, and the cell corresponding to the frequency band is barred. When the sector is selected as the subject of the barring, the sector is sequentially switched. When the eNodeB is selected as the subject of the barring, the area covered by the eNodeB is barred.

When the type of the call is set to be the target of the barring, the subject of the barring may be selected among mobile originated signaling from user equipment, a mobile originated call from user equipment, and a circuit switch service. One of the mobile originated signaling from the user equipment, the mobile originated call from the user equipment, and the circuit switch service may be selected, or more than one of them may be selected.

When the type of the user equipment is set to be the target of the barring, the subject of the barring may be selected among user equipment of a general user, user equipment of a user who is preferentially connected, and user equipment of a person who performs maintenance or the like. One of the user equipment of the general user, the user equipment of the user who is preferentially connected, and the user equipment of the person who performs maintenance or the like may be selected, or more than one of them may be selected.

When the type of the user equipment is set to be the target of the barring, a setting may be made so that communication from user equipment of a general user is to be barred, as the subject of the barring. Depending on necessity, the communication from the user equipment of the user who is preferentially connected may be barred, or the communication from the user equipment of the person who performs maintenance or the like may be barred.

In the example shown in FIG. 4, the cell and the type of the user equipment are selected as the targets of the barring. Further, when the target of the barring is the cell, the sector is selected as the subject of the barring. When the target of the barring is the type of the user equipment, the user equipment of the general user is selected as the subject of the barring.

The eNodeB 200 sets a time interval of the barring, based on the congestion level (step S408). Namely, the barring time interval setting unit 206 sets a time interval of regulating the target of the barring, where the target of the barring is selected by the barring target setting unit 204. A defined time interval may be set in a single uniform way, or the time interval of the barring may be set depending on the congestion level. Specifically, for a case where the time interval of the barring is set depending on the congestion level, a table (not shown) may be prepared in which the congestion level is associated with the time interval of the barring. Further, for each of the targets of the barring, a table may be prepared, in which a congestion level is associated with a time interval of the barring. By preparing the table for each of the targets of the barring, different time intervals of the barring may be set for the corresponding targets of the barring.

For the example shown in FIG. 4, the time interval of the barring is selected to be 5 seconds.

The eNodeB 200 inserts system information modification into the paging message (step S410). Namely, the system information editing unit 208 inserts the system information modification, which indicates that the system information is modified, into the paging message. Here, the paging message is to be transmitted prior to the system information.

The eNodeB 200 edits the system information (step S412). Namely, the system information editing unit 208 edits the system information including information representing the sector which is the target of the barring; information representing that the mobile originated call from the user equipment of the general user is to be barred; and information representing the time interval of the barring.

The eNodeB 200 sets N, which represents the identifier (identification number) of the cell, to be 1 (step S414). Namely, the barring target setting unit 204 and the barring time interval setting unit 206 set N, which represents the identification number of the cell, to be 1.

The eNodeB 200 transmits the paging message to the user equipment units in an Nth cell, which is represented by the identification number of N (step S416). Namely, the transmitter 210 transmits the paging message in the Nth cell. By transmitting the paging message, a notification can be made to the user equipment units in the Nth cell that the system information including the modified information is to be transmitted, subsequent to the termination of the current BCCH modification period.

The eNodeB 200 transmits the modified system information in the Nth cell (step S418). Namely, the transmitter 210 transmits the system information in the Nth cell. By transmitting the system information, the system information can be transmitted to the user equipment in the Nth cell.

The eNodeB 200 determines whether N, which represents the identification number of the cell, is equal to G, which represents the number of the cells (step S420). Namely, the barring target setting unit 204 and the barring time interval setting unit 206 determine whether N, which represents the identification number of the cell, is equal to G, which represents the number of the cells.

When a determination is made that N, which represents the identification number of the cell, is equal to G, which represents the number of the cells (step S420: YES), the process terminates. The process may return to step S402, and the process of measuring the congestion state may be restarted. The process of measuring the congestion state may be performed regularly or irregularly.

When a determination is made that N, which represents the identification number of the cell, is not equal to G, which represents the number of the cells (step S420: NO), the eNodeB 200 sets current N to be the number obtained by adding 1 to N (step S422), and the process returns to step S416. Namely, the barring target setting unit 204 and the barring time interval setting unit 206 set the current N to be the number which is obtained by adding 1 to N, and continue the same process until N, which represents the identification number of the cell, becomes equal to G, which represents the number of the cells.

The processes of steps S402-S422 are executed by a central processing unit (not shown) which is included in the eNodeB 200. A program that causes the central processing unit to function as the eNodeB 200 may be provided in a state where the program is stored in a recording medium such as a flexible disk, a CD-ROM, a memory card, and the like. Further, the program may be downloaded through a communication network (not shown). When the recording medium is inserted into an auxiliary storage device of a computer, the program which is stored in the recording medium is read out. The central processing unit writes the read program in a RAM-or in a HDD, and executes the process. The program causes the computer to execute each of steps S402-S422 of FIG. 4. Alternatively, for example, the program may cause at least a part of the steps to be executed.

In the flowchart shown in FIG. 4, the order of step S408, step S410, and step S412 may be changed, or step S408, step S410, and step S412 may be simultaneously performed.

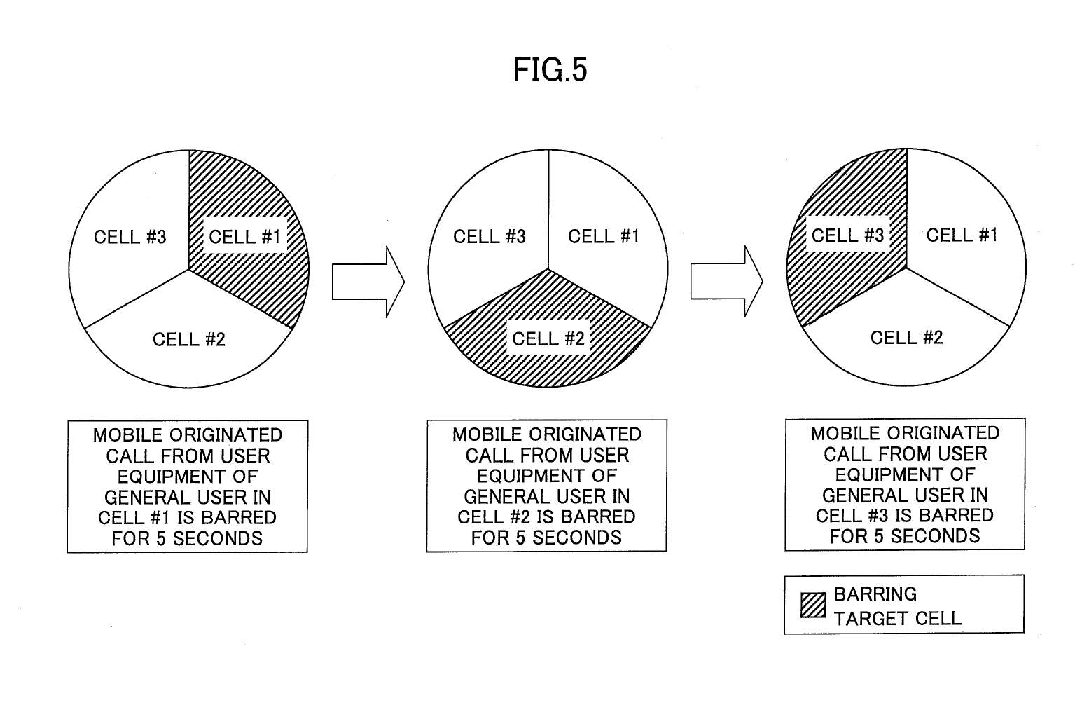

FIG. 5 shows operations of the eNodeB 200. The eNodeB 200 executes the processes in accordance with the flowchart shown in FIG. 4.

A mobile originated call from user equipment of a general user in a cell #1 is barred for five seconds. Subsequent to the barring of the mobile originated call from the user equipment of the general user in the cell #1, a mobile originated call from user equipment of a general user in a cell #2 is barred for five seconds. Subsequent to the barring of the mobile originated call from the user equipment of the general user in the cell #2, a mobile originated call from user equipment of a general user in a cell #3 is barred for five seconds.

Since the cell, in which the mobile originated call from the user equipment of the general user is barred, is sequentially switched, uplink signals from each of the units of user equipment can be equally barred.

In the above-described example, as the target of the barring, the cell, the type of the call, and the type of the user equipment, may be selected, while they include other items.

According to the above-described example, when the eNodeB is congested, uplink signals to the eNodeB can be barred by switching the target of the barring.

With respect to the embodiment including the above-described example, the following items are further disclosed.

(1) A base station performs radio communication with user equipment. The base station includes a congestion state determination unit that determines whether the base station is in a congestion state; a barring target setting unit that sequentially sets targets of barring among a plurality of the targets of the barring when the congestion state determination unit determines that the base station is in the congestion state; a barring time interval setting unit that sets a time interval of the barring based on the congestion state when the congestion state determination unit determines that the base station is in the congestion state; a notification information generating unit that generates information for transmitting information which represents the targets of the barring and information which represents the time interval of the barring, wherein the targets of the barring are to be set by the barring target setting unit, and the time interval of the barring is to be set by the barring time interval setting unit; and a transmitter that transmits the information generated by the notification information generating unit to the user equipment.

(2) In the base station described in (1), the barring target setting unit may select the targets of the barring among a cell, a type of a call, and a type of the user equipment.

(3) In the base station described in (2), when the barring target setting unit selects the cell as the target of the barring, the barring target setting unit may specify the cell, which is to be barred, by at least one of a frequency and an identifier of the cell.

(4) In the base station described in (2), when the barring target setting unit selects the type of the call as the target of the barring, the barring target setting unit may specify the type of the call by at least one of a mobile originated call from the user equipment, mobile originated signaling from the user equipment, and a circuit switch service, wherein the type of the call is to be barred.

(5) In the base station described in (2), when the barring target setting unit selects the type of the user equipment as the target of the barring, the barring target setting unit may specify the user equipment by at least one of the user equipment of a general user, the user equipment of a user who is preferentially connected, and the user equipment of a person who performs maintenance, wherein the type of the user equipment is to be barred.

(6) In the base station described in (1), the notification information generating unit may generate system information including information for transmitting a paging message which includes information indicating that broadcast information is modified; information which represents the targets to be barred, wherein the targets to be barred are to be set by the barring target setting unit; and information representing the time interval of the barring, wherein the time interval of the barring is to be set by the barring time interval setting unit.

(7) A communication control method is a method of a base station that performs radio communication with user equipment. The communication control method includes a congestion state determination step of determining whether the base station is in a congestion state; a barring target setting step of sequentially setting targets of barring among a plurality of the targets of the barring when the congestion state determination step determines that the base station is in the congestion state; a barring time interval setting step of setting a time interval of the barring based on the congestion state when the congestion state determination step determines that the base station is in the congestion state; a notification information generating step of generating information for transmitting information which represents the targets of the barring and information which represents the time interval of the barring, wherein the targets of the barring are to be set by the barring target setting step, and the time interval of the barring is to be set by the barring time interval setting step; and a transmission step of transmitting the information generated by the notification information generating step to the user equipment.

For the convenience of the explanation, specific examples of numerical values are used in order to facilitate understanding of the invention. However, these numerical values are simply illustrative, and any other appropriate values may be used, except as indicated otherwise.

Hereinabove, the present invention is explained by referring to the specific embodiments. However, the embodiments are merely illustrative, and variations, modifications, alterations and substitutions could be conceived by those skilled in the art. For the convenience of the explanation, the devices according to the embodiment of the present invention are explained by using functional block diagrams. However, these devices may be implemented in hardware, software, or combinations thereof. The present invention is not limited to the above-described embodiment, and various variations, modifications, alterations, substitutions and so on are included, without departing from the spirit of the present invention.

The present application is based on and claims the benefit of priority of Japanese Patent Application No. 2011-098678 filed on Apr. 26, 2011, the entire contents of which are hereby incorporated by reference.

### LIST OF REFERENCE SYMBOLS

100ₙ (n is an integer such that n>0): User equipment

200: eNodeB

202: Congestion state determination unit

204: Barring target setting unit

206: Barring time interval setting unit

208: System information editing unit

210: Transmitter

250ₘ (m is an integer such that m>0): Cell

1. A base station that performs radio communication with user equipment, the base station comprising:
a congestion state determination unit that determines whether the base station is in a congestion state;
a barring target setting unit that sequentially sets targets of barring among a plurality of the targets of the barring when the congestion state determination unit determines that the base station is in the congestion state;
a barring time interval setting unit that sets a time interval of the barring based on the congestion state when the congestion state determination unit determines that the base station is in the congestion state;
a notification information generating unit that generates information for transmitting information which represents the targets of the barring and information which represents the time interval of the barring, wherein the targets of the barring are to be set by the barring target setting unit, and the time interval of the barring is to be set by the barring time interval setting unit; and
a transmitter that transmits the information generated by the notification information generating unit to the user equipment.

2. The base station according to claim 1,
wherein the barring target setting unit selects the targets of the barring among a cell, a type of a call, and a type of the user equipment.

3. The base station according to claim 2,
wherein, when the barring target setting unit selects the cell as the target of the barring, the barring target setting unit specifies the cell by at least one of a frequency and an identifier of the cell, wherein the cell is to be barred.

4. The base station according to claim 2,
wherein, when the barring target setting unit selects the type of the call as the target of the barring, the barring target setting unit specifies the type of the call by at least one of a mobile originated call from the user equipment, mobile originated signaling from the user equipment, and a circuit switch service, wherein the type of the call is to be barred.

5. The base station according to claim 2,
wherein, when the barring target setting unit selects the type of the user equipment as the target of the barring, the barring target setting unit specifies the user equipment by at least one of the user equipment of a general user, the user equipment of a user who is preferentially connected, and the user equipment of a person who performs maintenance, wherein the type of the user equipment is to be barred.

6. The base station according to claim 1,
wherein the notification information generating unit generates system information including information for transmitting a paging message which includes information indicating that broadcast information is modified; information which represents the targets to be barred, wherein the targets to be barred are to be set by the barring target setting unit; and information representing the time interval of the barring, wherein the time interval of the barring is to be set by the barring time interval setting unit.

7. A communication control method of a base station that performs radio communication with user equipment, the communication control method comprising:
a congestion state determination step of determining whether the base station is in a congestion state;
a barring target setting step of sequentially setting targets of barring among a plurality of the targets of the barring when the congestion state determination step determines that the base station is in the congestion state;
a barring time interval setting step of setting a time interval of the barring based on the congestion state when the congestion state determination step determines that the base station is in the congestion state;
a notification information generating step of generating information for transmitting information which represents the targets of the barring and information which represents the time interval of the barring, wherein the targets of the barring are to be set by the barring target setting step, and the time interval of the barring is to be set by the barring time interval setting step; and
a transmission step of transmitting the information generated by the notification information generating step to the user equipment.
